(19) United States
(12) Patent Application Publication
(10) Pub. No.: US 2016/0110671 A1
(43) Pub. Date: Apr. 21, 2016

(54) SYSTEMS AND METHODS FOR VALUING A MERCHANT USING TRANSACTION DATA

(71) Applicant: MasterCard International Incorporated, Purchase, NY (US)

(72) Inventors: Debashis Ghosh, Charlotte, NC (US); Randy Shuken, Westport, CT (US); Todd Woodruff, St. Charles, MO (US)

(21) Appl. No.: 14/518,918

(22) Filed: Oct. 20, 2014

(51) Int. Cl. G06Q 10/06; G06Q 40/00; G06Q 40/02

(52) U.S. Cl. CPC G06Q 10/06393; G06Q 40/025; G06Q 40/12

(57) ABSTRACT

A computer implemented method for valuing a merchant based on payment card transactions is provided. The method uses a merchant valuation computing device in communication with a memory. The method includes receiving a valuation request message including a merchant identifier and a report range, receiving a plurality of payment card transactions initiated by cardholders with a merchant associated with the merchant identifier where the plurality of payment card transactions occurred during the report range, determining one or more valuation criteria for the merchant based on the plurality of payment card transactions, and generating a valuation report for the merchant based on the one or more valuation criteria, and transmitting the valuation report.

### BACKGROUND OF THE DISCLOSURE

The field of the invention relates generally to evaluating a merchant, and more specifically to systems and methods for valuing a merchant using payment card transactions associated with the merchant.

In today's business world, it is not unusual for small businesses and self-employed people to apply with lenders for small business loans and mortgages. In determining whether to grant such loans to an applicant, a lender will consider whether the applicant is able to repay the loan plus the negotiated interest amount. More specifically, the lender will review the applicant's income relative to the loan amount requested to determine whether to lend to the applicant. In some cases, the lender may calculate a risk associated with lending to the applicant wherein the risk is calculated based on the applicant's income and the requested loan amount. When the applicant is a self-employed person, it is sometimes difficult to determine the applicant's income. For example, a self-employed person that is a small business owner may or may not pay themselves a salary, and their income may be related to the value of their business (e.g., based on revenue or cash flow). Thus, when applying for loans with a lender, a small business owner may be required to submit financial information including a business plan, a tax return, or other financial statements to indicate the value of their business. Oftentimes, the financial information is unaudited (or unverified) and, in performing due diligence, the lender may wish to obtain validation that the indicated value of the business is accurate.

### BRIEF DESCRIPTION OF THE DISCLOSURE

In one embodiment, a computer implemented method for valuing a merchant based on payment card transactions is provided. The method uses a merchant valuation computing device in communication with a memory. The method includes receiving by the merchant valuation computing device a valuation request message including a merchant identifier and a report range, and receiving by the merchant valuation computing device a plurality of payment card transactions initiated by cardholders with a merchant associated with the merchant identifier. The plurality of payment card transactions occurred during the report range. The method also includes determining by the merchant valuation computing device one or more valuation criteria for the merchant based on the plurality of payment card transactions, generating by the merchant valuation computing device a valuation report for the merchant based on the one or more valuation criteria, and transmitting the valuation report.

In another embodiment, a merchant valuation computing device for valuing a merchant based on payment card transactions is provided. The merchant valuation computing device comprising one or more processors communicatively coupled to one or more memory devices. The merchant valuation computing device is configured to receive a valuation request message including a merchant identifier and a report range, and receive a plurality of payment card transactions initiated by cardholders with a merchant associated with the merchant identifier where the plurality of payment card transactions occurred during the report range, determine one or more valuation criteria for the merchant based on the plurality of payment card transactions, generate a valuation report for the merchant based on the one or more valuation criteria, and transmit the valuation report.

In yet another embodiment, a computer-readable storage medium having computer-executable instructions embodied thereon is provided. When executed by a merchant valuation computing device having at least one processor coupled to at least one memory device, the computer-executable instructions cause the processor to receive a valuation request message including a merchant identifier and a report range, receive a plurality of payment card transactions initiated by cardholders with a merchant associated with the merchant identifier where the plurality of payment card transactions occurred during the report range, determine one or more valuation criteria for the merchant based on the plurality of payment card transactions, generate a valuation report for the merchant based on the one or more valuation criteria, and transmit the valuation report.

### BRIEF DESCRIPTION OF THE DRAWINGS

FIGS. 1-6 show example embodiments of the methods and systems described herein.

FIG. 1 is a schematic diagram illustrating an example multi-party transaction card industry system for enabling ordinary payment-by-card transact in which merchants and card issuers do not need to have a one-to-one special relationship.

FIG. 2 is a simplified block diagram of an example computer system used for valuing a merchant in accordance with one example embodiment of the present disclosure.

FIG. 3 illustrates an example configuration of a client system shown in FIG. 2, in accordance with one embodiment of the present disclosure.

FIG. 4 illustrates an example configuration of the server system shown in FIG. 2, in accordance with one embodiment of the present disclosure.

FIG. 5 is a flowchart illustrating an example of a process of valuing a merchant based on payment transactions using the system shown in FIG. 2, in accordance with one embodiment of the disclosure.

FIG. 6 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, and describes several embodiments, adaptations, variations, alternatives, and uses of the disclosure, including what is presently believed to be the best mode of carrying out the disclosure. The disclosure is described as applied to an example embodiment, namely, systems and methods for valuing a merchant using payment card transaction data. More specifically, the disclosure describes a merchant valuation (“MV”) computing device configured to receive payment card transaction data for a merchant, determine one or more valuation criteria for the merchant based on the payment card transaction data, and provide a valuation report based on the valuation criteria to the merchant and/or a potential lender of the merchant.

In the example embodiment, the MV computing device is in communication with a payment card processing network (e.g., an interchange network). The MV computing device receives a valuation request that includes a merchant identifier and a report range. The merchant identifier is associated with a particular merchant. The report range includes the date range for the report (e.g., the last year, a particular calendar year, a series of months). In some embodiments, the valuation request further includes a definition of the periods which are sub-sets of the report range (e.g., month). In other embodiments, the periods are predefined. The MV computing device may receive the valuation request from the merchant associated with the merchant identifier or from some other third party, e.g., a lender. In the example embodiment, the MV computing device is in communication with the interchange network and retrieves the payment transactions initiated with the identified merchant over the report range from the interchange network. In other embodiments, the MV computing device is a part of the interchange network and retrieves the payment transactions from a database.

Each payment transaction includes a transaction amount. The transaction amount is a value representing the cost of goods and/or services associated with each transaction. In the example embodiment, the transaction amount may be a positive value, a negative value, or a zero value (e.g., a value that is neither positive nor negative). A transaction amount having a positive value may represent a purchase, a transaction amount having a negative value may represent a return, and a transaction amount having a zero value may represent a combination of purchases and returns or other transaction types (e.g., a transaction for complimentary goods). In some embodiments, the transaction amount may be any appropriate value and may include additional information to identify whether a transaction is a purchase, a return, or other transaction type.

The MV computing device determines valuation criteria for the merchant based on the payment transactions. In the example embodiment, the valuation criteria include a transaction volume amount, an average transaction amount, a stability score, and a loyalty score. In some embodiments, the valuation request includes the desired criteria and the MV computing device determines only the desired criteria.

The MV computing device calculates a transaction volume amount and an average transaction amount based on the payment transactions. The MV computing device calculates the transaction volume amount by adding together the transaction amounts for the entire report range. The MV computing device also calculates a transaction volume amount for each period. The MV computing device calculates an average transaction amount for the entire report range and for each period by dividing the transaction volume for that period by the number of transactions that occurred in that period. In some embodiments, the MV computing device only uses positive transaction amounts (e.g., purchases). In other embodiments, the MV computing device compares the transactions of each cardholder to determine a transaction amount for the cardholder, where the purchases and returns of the cardholder are included in the calculations.

The MV computing device calculates a stability score for the merchant based on the retrieved payment transactions. The stability score represents the fluctuation of the merchant's income from transactions during the report range. For example, a high stability score may indicate that the merchant's income remains relatively stable throughout the report period. A low stability score may indicate that the merchant's income fluctuated significantly during the report period. Some categories of merchants have significant fluctuation during certain periods of the year, e.g., retail merchants right before Christmas and florists in February. In the example embodiment, the MV computing device calculates the stability score based on the standard deviation of the average transaction amounts for each period in the report range, where the stability score is inversely proportional to the calculated standard deviation. In some embodiments, the MV computing device calculates the stability score based on the standard deviation of the transaction amounts of all of the payment transactions. In other embodiments, the loyalty score is associated with the stability score for merchant and the MV computing device calculates the stability score based on the loyalty score.

The MV computing device calculates a loyalty score for the merchant based on the retrieved payment transactions. The loyalty score is based on cardholders who initiate multiple payment transactions with the same merchant and represents the amount of repeat business that merchant conducts. In some embodiments, the MV computing device calculates the loyalty score as a percentage of the transaction volume amount originating from cardholders with multiple transactions. In other embodiments, the MV computing device calculates the loyalty score as a ratio of payment transactions initiated by cardholders with multiple transactions over the total number of payment transactions. In still other embodiments, the MV computing device calculates the loyalty score as a ratio of cardholders who initiated multiple payment transactions with the merchant to the total number of cardholders who initiated payment transactions with the merchant.

In the example embodiment, the MV computing device combines the transaction volume amount, the average transaction amount, the stability score, and the loyalty score to generate the valuation report. In some embodiments, the valuation report includes a plurality of values for each included valuation criteria. the MV computing device transmits the valuation report to the party who initiated the valuation request. In some embodiments, the MV computing device transmits the valuation report via an electronic communication (e.g., email). In other embodiments, the MV computing device transmits the valuation report to a client system to be displayed by an interface (e.g., a website).

In other embodiments, the MV computing device receives, from a requestor, a valuation request which includes a plurality of merchants. The MV computing device determines the valuation criteria for each merchant. The valuation request also includes one or more desire thresholds. The MV computing device determines one or more merchants from the plurality of merchants whose determined valuation criteria exceed the desired thresholds. The MV computing device transmits a report including the determined one or more merchants to the requestor.

In still other embodiments, the MV computing device provides alerts based on the valuation criteria. More specifically, the MV computing device receives an alert request from a requestor. In one embodiment, the alert request includes a merchant identifier and a criteria threshold. The MV computing device continually calculates the valuation criteria associated with the criteria threshold. When the valuation criterion exceeds the criteria threshold, the MV computing device transmits an alert to the requestor. In another embodiment, the alert request includes a merchant identifier, one or more valuation criteria, and an alert frequency. The MV computing device determines the one of more valuation criteria on a periodic basis based on the alert frequency. The MV computing device generates a valuation report and transmits the valuation report to the requestor on the periodic basis. In some embodiments, the MV computing device transmits an alert when a change in a valuation criterion exceeds a delta threshold.

In the example embodiment, the MV computer device receives transaction data without including any protected personal information. Personally identifiable information (PII) is information that can be used on its own or with other information to identify, contact, or locate a single person, or to identify an individual in context. Accordingly, information which can identify a purchaser is not stored at the MV computer device. In alternative embodiments, personally identifiable information may be otherwise safeguarded by the policies of systems using merchant profiles. In such alternative embodiments, personally identifiable information may be available, for example if the individual consents to his PII being available.

The methods and systems described herein may be implemented using computer programming or engineering techniques including computer software, firmware, hardware, or any combination or subset. As disclosed above, at least one technical problem with known systems is that there is no efficient way to value a merchant. The systems and methods described herein address that technical problem. The technical effect of the systems and processes described herein is achieved by performing at least one of the following steps: (a) receiving, from a payment network, transaction data for a plurality of transactions involving a selected merchant during a specified time period (e.g., one year); (b) determining an initiating cardholder and a payment amount for each transaction of the plurality of transactions; (c) calculating a transaction volume amount, an average transaction amount, and a stability score for the selected merchant using the payment amount for each transaction of the plurality of transactions; (d) calculating a loyalty score for the selected merchant based on the determined initiating cardholder for each transaction of the plurality of transactions; (e) generating a valuation report based on the transaction data; and (f) transmitting the valuation report to the selected merchant and/or a potential lender of the selected merchant. The valuation report includes the transaction volume amount, the average transaction amount, the stability score, and the loyalty score for the selected merchant during the specified time period. The resulting technical effect is that more accurate data about the merchant and the value of the merchant's business is provided without requiring the significant time and resources necessary to perform ordinary due diligence.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

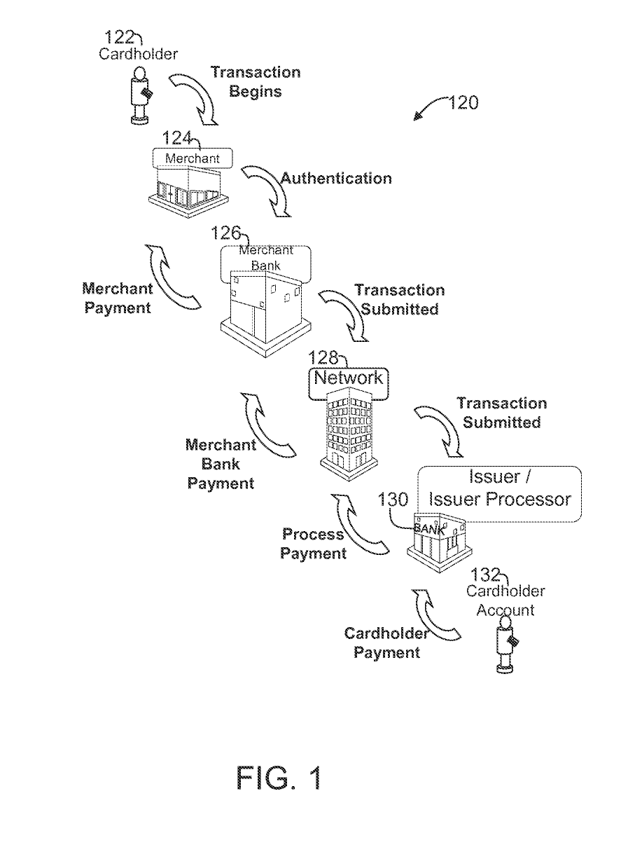

FIG. 1 is a schematic diagram illustrating an example multi-party transaction card industry system 120 for enabling ordinary payment-by-card transactions in which merchants 124 and card issuers 130 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

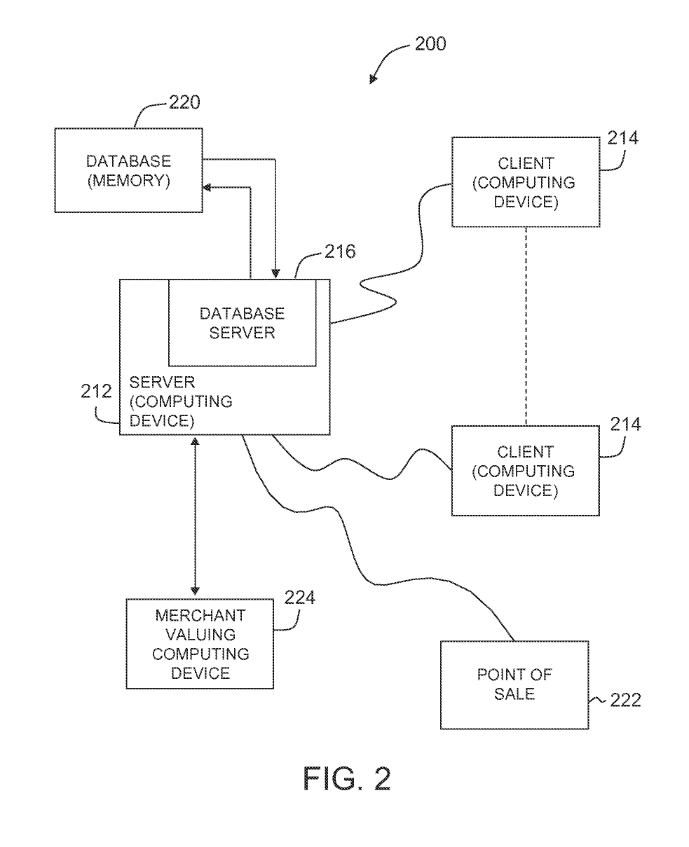

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 used for valuing a merchant in accordance with one example embodiment of the present disclosure. In the example embodiment, system 200 may be used for performing payment-by-card transactions received as part of processing cardholder transactions. In addition, system 200 is a payment processing system that includes a merchant valuation (“MV”) computing device 224 configured to value individual merchants based on payment card transactions initiated at the merchant. As described below in more detail, MV computing device 224 is configured to receive payment card transaction data for a merchant, determine one or more valuation criteria for the merchant based on the payment transaction data, and provide a valuation report based on the valuation criteria to the merchant and/or a potential lender of the merchant.

In the example embodiment, client systems 214 are computers that include a web browser or a software application, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 220 that stores data. In one embodiment, database 220 includes transaction information from a plurality of cardholders and paths based on those transactions. In the example embodiment, database 220 is stored remotely from server system 212. In some embodiments, database 220 is decentralized. In the example embodiment, a person can access database 220 via client systems 214 by logging onto server system 212, as described herein.

MV computing device 224 is communicatively coupled with the server system 212. MV computing device 224 can access the server system 212 to store and access data and to communicate with the client systems 214 through the server system 212. In some embodiments, MV computing device 224 may be associated with, or is part of the payment system, or in communication with the payment card system payment network 120, shown in FIG. 1. In other embodiments, MV computing device 224 is associated with a third party and is merely in communication with the payment network 120. In some embodiments, MV computing device 224 may be associated with, or be part of merchant bank 126, interchange network 128, and issuer bank 130, all shown in FIG. 1.

One or more point of sale systems 222 are communicatively coupled with the server system 212. The one or more point of sale systems 222 can be merchants 124 shown in FIG. 1, where the point of sale systems 222 are communicatively coupled with the server system through the payment network 120. Point of sale systems 222 may be, but are not limited to, machines that accept card swipes, online payment portals, or stored payment card numbers for recurring transactions.

In some embodiments, server system 212 may be associated with a financial transaction interchange network 128, and may be referred to as an interchange computer system. Server system 212 may be used for processing transaction data and analyzing for fraudulent transactions. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 or point of sales systems 222 may include point-of-sale (POS) devices associated with a merchant and used for processing payment transactions. At least one client system 214 may be used for investigating potential breaches.

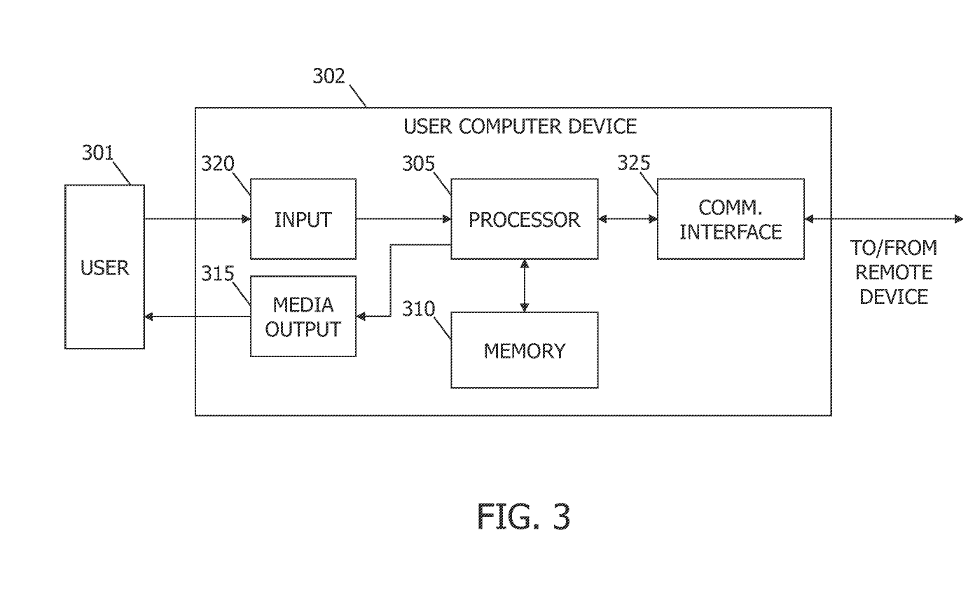

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214 and MV computing device 224 (both shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

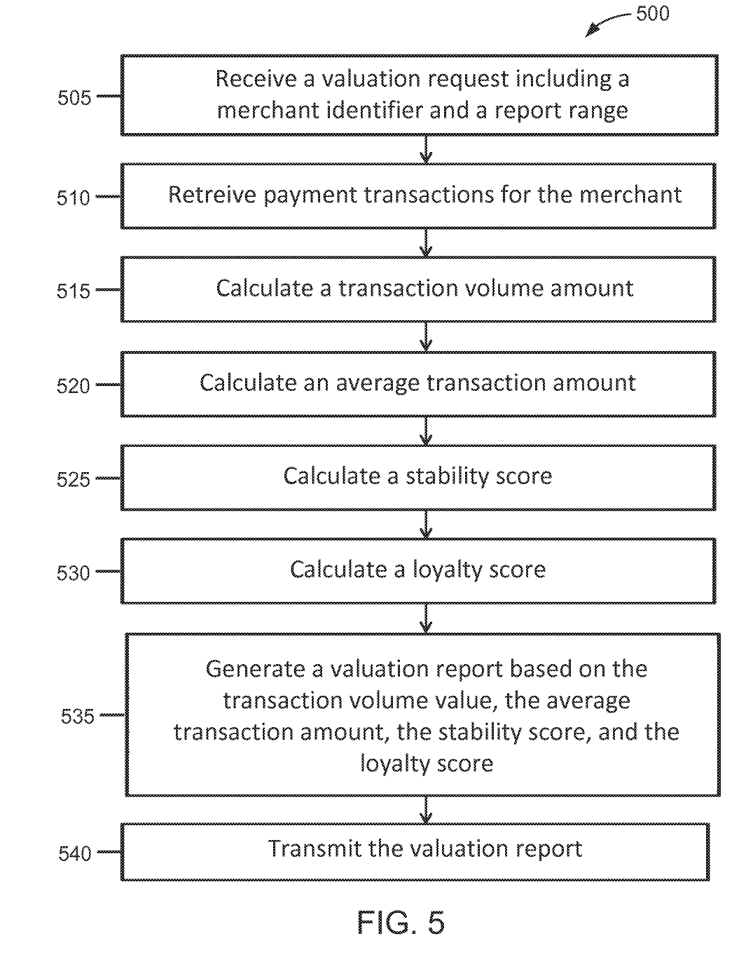

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 is programmed with the instruction such as illustrated in FIG. 5.

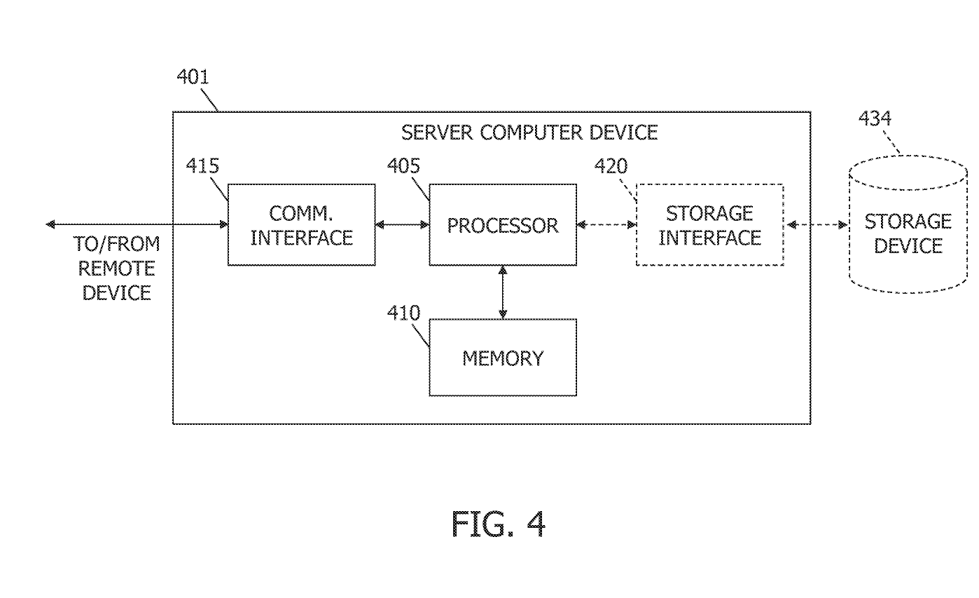

FIG. 4 illustrates an example configuration of the server system 212 shown in FIG. 2, in accordance with one embodiment of the present disclosure. Server computer device 401 may include, but is not limited to, database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, or MV computing device 224 (both shown in FIG. 2). For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

FIG. 5 is a flowchart illustrating an example of a process 500 of valuing merchant 124 (shown in FIG. 1) based on payment transactions using system 200 shown in FIG. 2, in accordance with one embodiment of the disclosure. Process 500 may be implemented by a computing device, for example MV computing device 224 (shown in FIG. 2). In the example embodiment, MV computing device 224 is in communication with a payment card processing network (e.g., an interchange network 128, shown in FIG. 1).

MV computing device 224 receives 505 a valuation request that includes a merchant identifier and a report range. The merchant identifier is associated with a particular merchant 124. The report range includes the date range for the report (e.g., the last year, a particular calendar year, a series of months). In some embodiments, the valuation request further includes a definition of the periods which are sub-sets of the report range (e.g., month). In other embodiments, the periods are predefined. MV computing device 224 receives 505 the valuation request from merchant 124 associated with the merchant identifier or from some other third party, e.g., a lender. In some embodiments, MV computing device 224 receives 505 the valuation request from a client system 214, as shown in FIG. 2. In the example embodiment, MV computing device 224 is in communication with interchange network 128 and retrieves 510 the payment transactions initiated with the identified merchant over the report range from interchange network 128. In other embodiments, MV computing device 224 is a part of interchange network 128 and retrieves 510 the payment transactions from database 220 (shown in FIG. 2).

MV computing device 224 determines valuation criteria for merchant 124 based on the payment transactions. In the example embodiment, the valuation criteria include a transaction volume amount, an average transaction amount, a stability score, and a loyalty score. In some embodiments, the valuation request includes the desired criteria and MV computing device 224 determines only the desired criteria.

MV computing device 224 calculates a transaction volume amount and an average transaction amount based on the payment transactions. MV computing device 224 calculates 515 the transaction volume amount by adding together the transaction amounts for the entire report range. MV computing device 224 also calculates 515 a transaction volume amount for each period. MV computing device 224 calculates 520 an average transaction amount for the entire report range and for each period by dividing the transaction volume for that period by the number of transactions that occurred in that period. In some embodiments, MV computing device 224 only uses positive transaction amounts (e.g., purchases). In other embodiments, MV computing device 224 compares the transactions of each cardholder to determine a transaction amount for the cardholder, where the purchases and returns of the cardholder are included in the calculations.

MV computing device 224 calculates 525 a stability score for merchant 124 based on the retrieved payment transactions. The stability score represents the fluctuation of the merchant's income from transactions during the report range. For example, a high stability score may indicate that the merchant's income remains relatively stable throughout the report period. A low stability score may indicate that the merchant's income fluctuated significantly during the report period. Some categories of merchants have significant fluctuation during certain periods of the year, e.g., retail merchants right before Christmas and florists in February. In the example embodiment, MV computing device 224 calculates 525 the stability score based on the standard deviation of the average transaction amounts for each period in the report range, where the stability score is inversely proportional to the calculated standard deviation. In some embodiments, MV computing device 224 calculates 525 the stability score based on the standard deviation of the transaction amounts of all of the payment transactions. In other embodiments, the loyalty score is associated with the stability score for merchant 124 and MV computing device 224 calculates 525 the stability score based on the loyalty score.

MV computing device 224 calculates 530 a loyalty score for merchant 124 based on the retrieved payment transactions. The loyalty score is based on cardholders who initiate multiple payment transactions with the same merchant and represents the amount of repeat business that merchant 124 conducts. In some embodiments, MV computing device 224 calculates 530 the loyalty score as a percentage of the transaction volume amount originating from cardholders with multiple transactions. In other embodiments, MV computing device 224 calculates 530 the loyalty score as a ratio of payment transactions initiated by cardholders with multiple transactions over the total number of payment transactions. In still other embodiments, MV computing device 224 calculates 530 the loyalty score as a ratio of cardholders who initiated multiple payment transactions with merchant 124 to the total number of cardholders who initiated payment transactions with merchant 124.

In the example embodiment, MV computing device 224 combines the transaction volume amount, the average transaction amount, the stability score, and the loyalty score to generate 535 the valuation report. In some embodiments, the valuation report includes a plurality of values for each included valuation criteria. MV computing device 224 transmits the valuation report to the party who initiated the valuation request. In some embodiments, MV computing device 224 transmits 540 the valuation report via an electronic communication (e.g., email). In other embodiments, MV computing device 224 transmits 540 the valuation report to client system 214 (shown in FIG. 2) to be displayed by an interface (e.g., a website).

In other embodiments, MV computing device 224 receives 505, from a requestor, a valuation request which includes a plurality of merchants. MV computing device 224 determines the valuation criteria for each merchant. The valuation request also includes one or more desire thresholds. MV computing device 224 determines one or more merchants from the plurality of merchants whose determined valuation criteria exceed the desired thresholds. MV computing device 224 transmits 540 a report including the determined one or more merchants to the requestor.

In still other embodiments, MV computing device 224 provides alerts based on the valuation criteria. More specifically, MV computing device 224 receives an alert request from a requestor. In one embodiment, the alert request includes a merchant identifier and a criteria threshold. MV computing device 224 continually calculates the valuation criteria associated with the criteria threshold. When the valuation criterion exceeds the criteria threshold, MV computing device 224 transmits an alert to the requestor. In another embodiment, the alert request includes a merchant identifier, one or more valuation criteria, and an alert frequency. MV computing device 224 determines the one of more valuation criteria on a periodic basis based on the alert frequency. MV computing device 224 generates a valuation report and transmits the valuation report to the requestor on the periodic basis. In some embodiments, MV computing device 224 transmits an alert when a change in a valuation criterion exceeds a delta threshold.

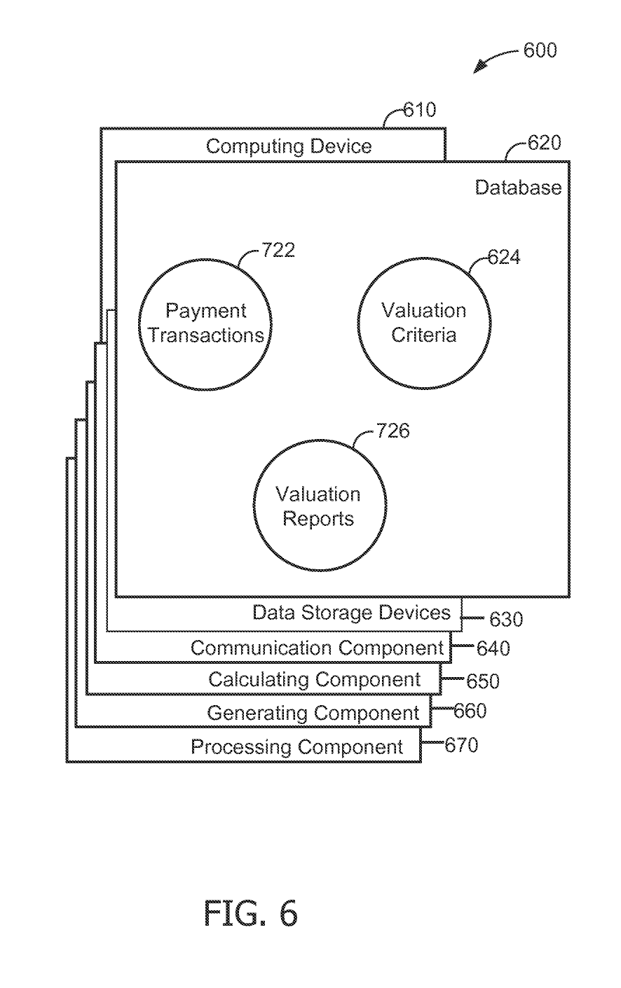

FIG. 6 is a diagram 600 of components of one or more example computing devices that may be used in the system 200 shown in FIG. 2. In some embodiments, computing device 610 is similar to server system 212; it may also be similar to MV computing device 224 (both shown in FIG. 2). Database 620 may be coupled with several separate components within computing device 610, which perform specific tasks. In this embodiment, database 620 includes payment transactions 622, valuation criteria 624, and valuation reports 626. In some embodiments, database 620 is similar to database 220 (shown in FIG. 2).

Computing device 610 includes the database 620, as well as data storage devices 630. Computing device 610 also includes a communication component 640 for receiving 505 a valuation request, retrieving 510 payment transactions, and transmitting 540 the valuation report (all shown in FIG. 5). Computing device 610 also includes a calculating component 650 for calculating 515 a transaction volume amount, calculating 520 an average transaction amount, calculating 525 a stability score, and calculating 530 a loyalty score (all shown in FIG. 5). A generating component 660 is also included for generating 535 a valuation report, as shown in FIG. 6. A processing component 670 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer implemented method for valuing a merchant based on payment card transactions, said method implemented using a merchant valuation computing device in communication with a memory, said method comprising:
receiving, by the merchant valuation computing device, a valuation request message including a merchant identifier and a report range;
receiving, by the merchant valuation computing device, a plurality of payment card transactions initiated by cardholders with a merchant associated with the merchant identifier, wherein the plurality of payment card transactions occurred during the report range;
determining, by the merchant valuation computing device, one or more valuation criteria for the merchant based on the plurality of payment card transactions;
generating, by the merchant valuation computing device, a valuation report for the merchant based on the one or more valuation criteria; and
transmitting the valuation report.

2. The method in accordance with claim 1, wherein the one or more valuation criteria include at least a transaction volume amount, an average transaction amount, a stability score, and a loyalty score.

3. The method in accordance with claim 1, wherein determining one or more valuation criteria further comprises calculating, by the merchant valuation computing device, a stability score for the merchant based on a standard deviation of a transaction amount from each of the plurality of payment card transactions.

4. The method in accordance with claim 1, wherein determining one or more valuation criteria further comprises calculating a loyalty score for the merchant based on a number of cardholders who conducted more than one payment transaction during the report range with the merchant.

5. The method in accordance with claim 1 wherein the valuation request message includes one or more desired valuation criteria and wherein the method further comprises generating the valuation report based on the one or more valuation criteria corresponding to the desired valuation criteria.

6. The method in accordance with claim 1, wherein the valuation request message further includes a plurality of merchant identifiers and one or more valuation thresholds, and wherein the method further comprises:
determining, for each of a plurality of merchants corresponding to the plurality of merchant identifiers, one or more valuation criteria values corresponding to each of the one or more valuation thresholds based on the plurality of payment card transactions;
generating a threshold report based on one or more merchants from the plurality of merchants whose one or more valuation criteria values exceeded at least one of the one or more valuation thresholds; and
transmitting the threshold report.

7. The method in accordance with claim 1, wherein the valuation request message further includes one or more valuation thresholds, and wherein the method further comprises:
periodically determining, for the merchant, one or more valuation criteria values corresponding to each of the one or more valuation thresholds;
comparing each of the one or more valuation criteria values with the corresponding valuation threshold; and
transmitting an alert when one of the valuation criteria values exceeds the corresponding valuation threshold.

8. The method in accordance with claim 1, wherein the valuation request message further includes one or more valuation criteria and a report frequency, and wherein the method further comprises:
determining, on a periodic basis based on the report frequency, one or more valuation criteria values associated with each of the one or more valuation criteria;
generating the valuation report based on the one or more valuation criteria values; and
transmitting, on the periodic basis, the valuation report.

9. The method in accordance with claim 1, wherein the report range includes a plurality of sub-periods, and wherein each valuation criteria of the one of more valuation criteria is determined for each sub-period.

10. A merchant valuation computing device comprising one or more processors communicatively coupled to one or more memory devices, said merchant valuation computing device configured to:
receive a valuation request message including a merchant identifier and a report range;
receive a plurality of payment card transactions initiated by cardholders with a merchant associated with the merchant identifier, wherein the plurality of payment card transactions occurred during the report range;
determine one or more valuation criteria for the merchant based on the plurality of payment card transactions;
generate a valuation report for the merchant based on the one or more valuation criteria; and
transmit the valuation report.

11. The merchant valuation computing device of claim 10, wherein the one or more valuation criteria include at least a transaction volume amount, an average transaction amount, a stability score, and a loyalty score.

12. The merchant valuation computing device of claim 10, wherein the merchant valuation computing device is further configured to calculate a stability score for the merchant based on a standard deviation of a transaction amount from each of the plurality of payment card transactions.

13. The merchant valuation computing device of claim 10, wherein the merchant valuation computing device is further configured to calculate a loyalty score for the merchant based on a number of cardholders who conducted more than one payment transaction during the report range with the merchant.

14. The merchant valuation computing device of claim 10, wherein the valuation request message further includes a plurality of merchant identifiers and one or more valuation thresholds, and wherein the merchant valuation computing device is further configured to:
determine, for each of a plurality of merchants corresponding to the plurality of merchant identifiers, one or more valuation criteria values corresponding to each of the one or more valuation thresholds based on the plurality of payment card transactions;
generate a threshold report based on one or more merchants from the plurality of merchants whose one or more valuation criteria values exceeded at least one of the one or more valuation thresholds; and
transmit the threshold report.

15. The merchant valuation computing device of claim 10, wherein the valuation request message further includes one or more valuation thresholds, and wherein the merchant valuation computing device is further configured to:
periodically determine, for the merchant, one or more valuation criteria values corresponding to each of the one or more valuation thresholds;
compare each of the one or more valuation criteria values with the corresponding valuation threshold; and
transmit an alert when one of the valuation criteria values exceeds the corresponding valuation threshold.

16. The merchant valuation computing device of claim 10, wherein the valuation request message further includes one or more valuation criteria and a report frequency, and wherein the merchant valuation computing device is further configured to:
determine, on a periodic basis based on the report frequency, one or more valuation criteria values associated with each of the one or more valuation criteria;
generate the valuation report based on the one or more valuation criteria values; and
transmit, on the periodic basis, the valuation report.

17. A computer-readable storage medium having computer-executable instructions embodied thereon, wherein when executed by a merchant valuation computing device having at least one processor coupled to at least one memory device, the computer-executable instructions cause the processor to:
receive a valuation request message including a merchant identifier and a report range;
receive a plurality of payment card transactions initiated by cardholders with a merchant associated with the merchant identifier, wherein the plurality of payment card transactions occurred during the report range;
determine one or more valuation criteria for the merchant based on the plurality of payment card transactions;
generate a valuation report for the merchant based on the one or more valuation criteria; and
transmit the valuation report.

18. The computer-readable storage medium of claim 17, wherein the one or more valuation criteria include at least a transaction volume amount, an average transaction amount, a stability score, and a loyalty score.

19. The computer-readable storage medium of claim 17, wherein the computer-executable instructions further cause the processor to calculate a stability score for the merchant based on a standard deviation of a transaction amount from each of the plurality of payment card transactions.

20. The computer-readable storage medium of claim 17, wherein the computer-executable instructions further cause the processor to calculate a loyalty score for the merchant based on a number of cardholders who conducted more than one payment transaction during the report range with the merchant.
